(19) United States
(12) Patent Application Publication
(10) Pub. No.: US 2014/0287835 A1
(43) Pub. Date: Sep. 25, 2014

(54) SOUND VIRTUALIZATION METHOD AND APPARATUS

(71) Applicant: Electronics & Telecommunications Research Institute, Daejeon (KR)

(72) Inventors: Kyoung Ill KIM, Seoul (KR); Su Young BAE, Daejeon (KR); Chang Sik CHO, Daejeon (KR); Hun Joo LEE, Daejeon (KR)

(73) Assignee: Electronics & Telecommunications Research Institute, Daejeon (KR)

(21) Appl. No.: 14/038,214

(22) Filed: Sep. 26, 2013

(30) Foreign Application Priority Data
Mar. 22, 2013 (KR) 10-2013-0030601

(51) Int. Cl. A63F 13/00

(52) U.S. Cl. CPC A63F 13/00
USPC 463/35

(57) ABSTRACT

Disclosed are a sound virtualization method and apparatus. The sound virtualization method includes generating virtual sound devices, generating virtual audio devices on the basis of an audio device, acquiring a mapping relation between sounds created by the virtual sound device and sounds output by the virtual audio device, acquiring the sounds from memories on the basis of the mapping relation, and outputting the sounds through the virtual audio devices according to the mapping relation. Accordingly, it is possible to provide sound to a plurality of users.

### CLAIM FOR PRIORITY

This application claims priority to Korean Patent Application No. 10-2013-0030601 filed on Mar. 22, 2013 in the Korean Intellectual Property Office (KIPO), the entire contents of which are hereby incorporated by reference.

### BACKGROUND

1. Technical Field

Example embodiments of the present invention relate in general to virtualization technology, and more specifically, to a sound virtualization method and apparatus.

2. Related Art

In general, an online game is based on a single server/client, which requires a high-specification client environment. Specifically, functions and performance of a game service to be provided may vary depending on performance of a client.

In order to run an online game, a client can require a high-specification processor, memory, graphics card, storage, etc., thereby wasting unnecessary resources.

### SUMMARY

Accordingly, example embodiments of the present invention are provided to substantially obviate one or more problems due to limitations and disadvantages of the related art.

Example embodiments of the present invention provide a sound virtualization method for supporting sound for a plurality of users through virtualization of a sound device.

Example embodiments of the present invention also provide a sound virtualization apparatus for supporting sound for a plurality of users through virtualization of a sound device.

In some example embodiments, a sound virtualization method includes generating a plurality of virtual sound devices on the basis of a sound device, generating a plurality of virtual audio devices on the basis of an audio device for outputting sound created by the sound device, acquiring a mapping relation between sounds created by the plurality of virtual sound devices and sounds output by the plurality of virtual audio devices, acquiring the sounds created by the plurality of virtual sound devices from memories on the basis of the mapping relation, and outputting the sounds acquired from the memories through the plurality of virtual audio devices according to the mapping relation.

The generating of the plurality of virtual sound devices may include determining the number of terminals receiving the sounds and generating as many of the virtual sound devices as the determined number of terminals.

The generating of the plurality of virtual audio devices may include generating as many of the virtual audio devices as the number of the virtual sound devices.

The acquiring of a mapping relation may include capturing the sounds created by the plurality of virtual sound devices, capturing the sounds output by the plurality of virtual audio devices, and acquiring the mapping relation on the basis of correspondence between the sounds captured by the plurality of virtual sound devices and the sounds captured by the plurality of virtual audio devices.

The acquiring of the sounds created by the plurality of virtual sound devices from memories on the basis of the mapping relation may include acquiring memory addresses storing the sounds to be transmitted through the plurality of virtual audio devices and acquiring the sounds stored at the memory addresses.

The sound virtualization method may further include streaming the sounds output through the virtual audio devices into the terminals.

The mapping relation may be a one-to-one mapping between one of the sounds created by the plurality of virtual sound devices and one of the sounds output by the plurality of virtual audio devices.

In other example embodiments, a sound virtualization apparatus includes a processing unit configured to generate a plurality of virtual sound devices on the basis of a sound device, generate a plurality of virtual audio devices on the basis of an audio device for outputting sound created by the sound device, acquire a mapping relation between sounds created by the plurality of virtual sound devices and sounds output by the plurality of virtual audio devices, acquire the sounds created by the plurality of virtual sound devices from memories on the basis of the mapping relation, and output the sounds acquired from the memories through the plurality of virtual audio devices according to the mapping relation; and a storage unit configured to store information processed or having been processed by the processing unit.

The processing unit, upon the generating of the plurality of virtual sound devices, may determine the number of terminals receiving the sounds and generating as many of the virtual sound devices as the determined number of terminals.

The processing unit, upon the generating of the plurality of virtual audio devices, may generate as many of the virtual audio devices as the number of the virtual sound devices.

The processing unit, upon the acquiring of the mapping relation, may capture the sounds created by the plurality of virtual sound devices, capture the sounds output by the plurality of virtual audio devices, and acquire the mapping relation on the basis of correspondence between the sounds captured by the plurality of virtual sound devices and the sounds captured by the plurality of virtual audio devices.

The processing unit, upon the acquiring of the sounds from memories on the basis of the mapping relation, may acquire memory addresses storing the sounds to be transmitted through the plurality of virtual audio devices and acquire the sounds stored at the memory addresses.

The processing unit may stream the sounds output through the virtual audio devices into the terminals.

The mapping relation may be a one-to-one mapping between one of the sounds created by the plurality of virtual sound devices and one of the sounds output by the plurality of virtual audio devices.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing a configuration of an online game system according to an embodiment of the present invention;

FIG. 2 is a block diagram showing a configuration of a game server according to an embodiment of the present invention;

FIG. 3 is a conceptual diagram showing a process of providing an online game according to an embodiment of the present invention;

FIG. 4 is a flowchart showing a sound virtualization method according to an embodiment of the present invention;

FIG. 5 is a flowchart showing a process of generating a virtual sound device in a sound virtualization method according to an embodiment of the present invention;

FIG. 6 is a flowchart showing a process of acquiring a mapping relation in a sound virtualization method according to an embodiment of the present invention;

FIG. 7 is a conceptual diagram showing a process of outputting sounds on the basis of the mapping relation according to an embodiment of the present invention;

FIG. 8 is a flowchart showing a process of acquiring sounds from memories in a sound virtualization method according to an embodiment of the present invention; and

FIG. 9 is a block diagram showing a sound virtualization apparatus according to an embodiment of the present invention.

### DESCRIPTION OF EXAMPLE EMBODIMENTS

While the invention is susceptible to various modifications and alternative forms, specific embodiments thereof are shown by way of example in the drawings and will herein be described in detail.

However, it should be understood that the particular embodiments are not intended to limit the present disclosure to specific forms, but rather the present disclosure is meant to cover all modification, similarities, and alternatives which are included in the spirit and scope of the present disclosure.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, numbers, steps, operations, elements, and/or components, but do not preclude the presence or addition of one or more other features, numbers, steps, operations, elements, components, and/or groups thereof.

Unless otherwise defined, all terms (including technical and scientific terms) used herein have the same meanings as commonly understood by one of ordinary skill in the art to which this invention belongs. It will be further understood that terms defined in common dictionaries should be interpreted within the context of the relevant art, yet not in an idealized or overly formal sense unless expressly so defined herein.

Embodiments of the present invention will be described below in more detail with reference to the accompanying drawings. In describing the invention, to facilitate the entire understanding of the invention, like numbers refer to like elements throughout the description of the figures, and a repetitive description on the same element is not provided.

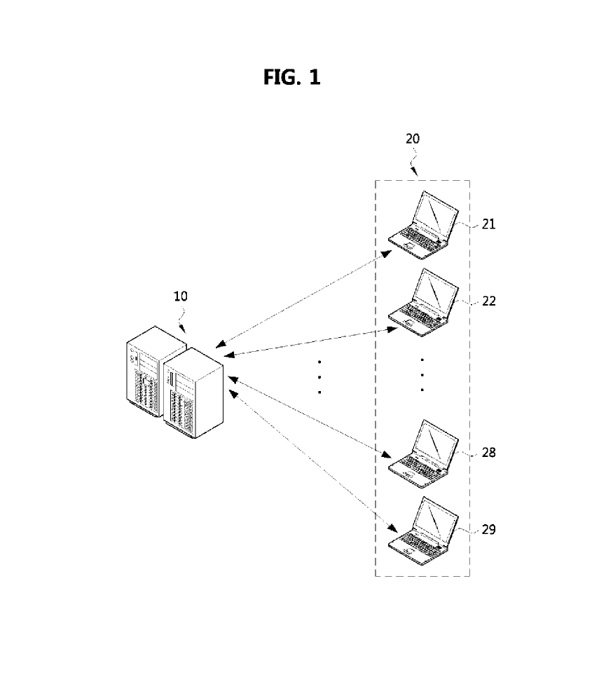

FIG. 1 is a conceptual diagram showing a configuration of an online game system according to an embodiment of the present invention.

Referring to FIG. 1, a game server 10 may be hardwired or wirelessly connected to at least one of terminals 21 to 29. Here, the terminals 21 to 29 may each denote a terminal used by a client. The game server 10 may provide an online game upon a request of each of the terminals 21 to 29. That is, the game server 10 may run a game on the game server 10 itself on the basis of the request of each of the terminals 21 to 29, and may provide the terminals 21 to 29 with execution screen information and game sound information about the running game. With the above configuration, the terminals 21 to 29 may run the online game regardless of their specifications.

The sound virtualization method and apparatus according to an embodiment of the present invention may be applied to the online game system shown in FIG. 1.

Here, when the game server 10 and the terminals 21 to 29 are connected over a network, the network may include a 2G mobile communication network such as Bluetooth, infrared communication, Global System for Mobile communication (GSM), and Code Division Multiple Access (CDMA), and a mobile communication network for supporting wireless Internet such as Wireless Fidelity (WiFi) or WiFi direct and portable Internet or packet transmission such as Wireless Broadband Internet (WiBro) or World Interoperability for Microwave Access (WiMax) (for example, a 3G mobile communication network such as Wideband Code Division Multiple Access (WCDMA) or CDMA2000, a 3.5G mobile communication network such as High-Speed Downlink Packet Access (HSDPA) or High-Speed Uplink Packet Access (HSUPA), and a 4G mobile communication network such as a Long Term Evolution (LTE) network or an LTE-Advanced network.

Here, the terminals 21 to 29 may each include a communication-enabled desktop computer, laptop computer, tablet PC, wireless phone, mobile phone, smartphone, e-book reader, portable multimedia player, portable gaming console, navigation device, digital camera, digital multimedia broadcasting (DMB) player, digital audio recorder, digital audio player, digital picture recorder, digital picture player, digital video recorder, digital video player, etc.

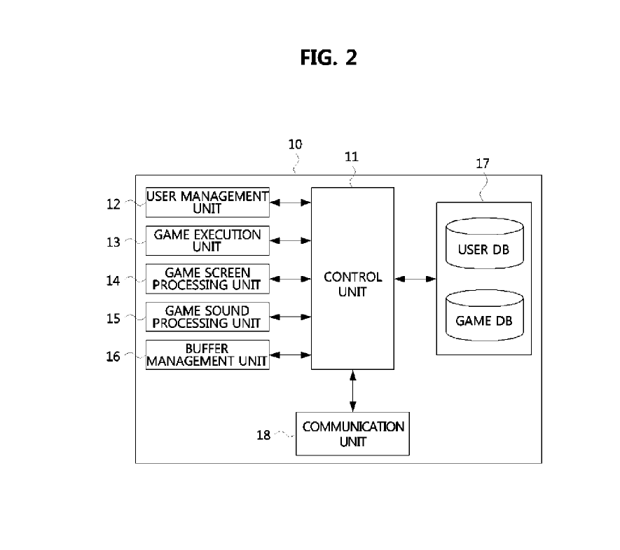

FIG. 2 is a block diagram showing a configuration of a game server according to an embodiment of the present invention.

Referring to FIG. 2, the game server 10 may include a control unit 11, a user management unit 12, a game execution unit 13, a game screen processing unit 14, a game sound processing unit 15, a buffer management unit 16, a database 17, and a communication unit 18. Here, the control unit 11 may control an operation of each element included in the game server 10.

The user management unit 12 may manage information about users. For example, the user management unit 12 may manage login information about a user, resolution information about a user terminal 20 (see FIG. 1), etc.

The game execution unit 13 may call a game list stored in the database 17 and provide the called game list to the terminal 20 of the logged-in user. Furthermore, the game execution unit 13 may execute a gamed selected by the user from the game list.

The game screen processing unit 14 may capture an execution screen about the game during execution of the game and encode the captured execution screen such that the encoded execution screen may be output by the terminal. For example, if the resolution of the terminal is 1024×768, the game screen processing unit 14 may encode a game execution screen such that the encoded game execution screen may have a resolution of 1024×768. Also, the game screen processing unit 14 may stream the encoded game execution screen into the terminal.

The game sound processing unit 15 may capture game sounds during execution of the game and stream the captured sounds into the terminal.

When game selection information is input by the terminal 20 of the user, the game selected by the user may be positioned in a free space of a frame buffer. At this point, information about the game positioned in the frame buffer may be recorded in a user table, and the game information may be recorded for each space of the buffer. Also, the buffer management unit 16 may remove the game information from the frame buffer and then reposition the frame buffer spaces when the game ends according to a request of the user terminal 20.

The database 17 may include a user DB, a game DB, etc. The user DB may include login information about a user, resolution information about the terminal 20 of the user, information about a game selected by the user, etc. The game DB may include games capable of being provided by the game server 10 and game list information about the games. Furthermore, the game DB may include game selection information, game execution information, etc.

The communication unit 18 may be hardwired or wirelessly connected to a plurality of user terminals 20 and communicate data with the plurality of user terminals 20.

The sound virtualization method and apparatus according to an embodiment of the present invention may be applied to the game server shown in FIG. 2.

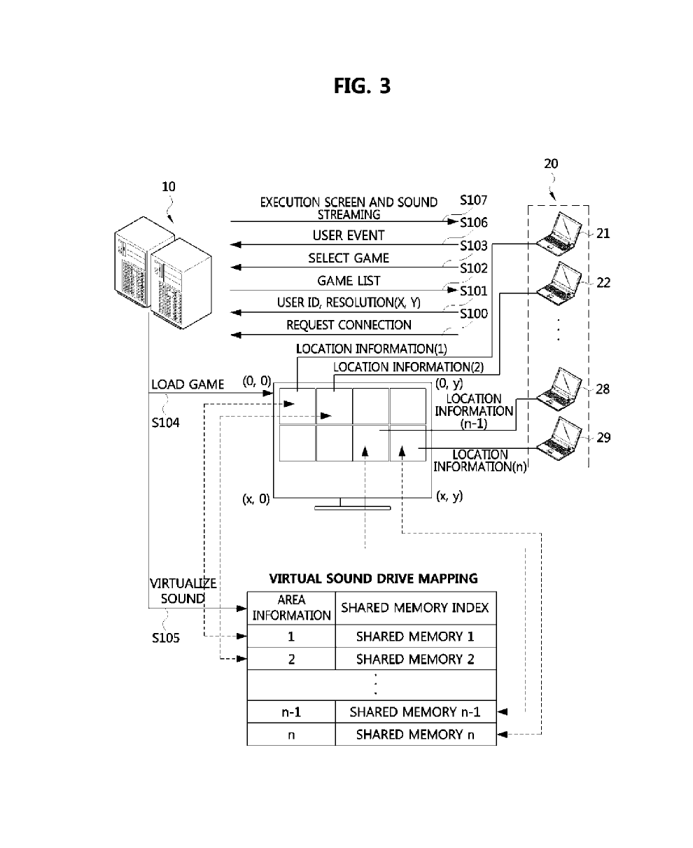

FIG. 3 is a conceptual diagram showing a process of providing an online game according to an embodiment of the present invention.

Referring to FIG. 3, the game server 10 may be hardwired or wirelessly connected to at least one of the terminals 21 to 29 and provide the online game service to at least one of the terminals 21 to 29.

First, the user may connect to the game server using his/her terminal 21 to 29 (S100) and provide the game server 10 with a user ID, resolution information about the terminal 21 to 29, and so on (S101). When the game server 10 receives the user ID, resolution information, etc., from the terminal 21 to 29, the game server 10 may perform a user authentication process and then provide a game list to an authenticated user terminal 21 to 29 (S102). Here, the game list may include information about at least one game provided by the game server 10. The user may select a game from the game list and provide information about the selected game to the game server 10 through the terminal 21 to 29 (S103).

The game server 10 may load the game selected by the user in a predetermined screen area. For example, the game server 10 may load a game for the first terminal 21 in the first location information area, a game for the second terminal 22 in the second location information area, a game for the (n−1)th terminal 28 in the (n−1)th location information area, and a game for the nth terminal 29 in the nth location information area.

The game server 10 may create game sounds through virtualization of the sound device (S105). If the online game service needs to be provided to the plurality of terminals 21 to 29, the game server 10 may generate as many of the virtual sound devices as the number of terminals 21 to 29 and create the game sounds through the generated virtual sound devices.

At this point, the game server 10 may create a sound of the game loaded in the first location information area through a first virtual sound device (that is, a first area information), create a sound of the game loaded in the second location information area through a second virtual sound device (that is, a second area information), create a sound of the game loaded in the (n−1)th location information area through a (n−1)th virtual sound device (that is, a (n−1)th area information), and create a sound of the game loaded in the nth location information area through an nth virtual sound device (that is, an nth area information).

An event generated by the user during execution of the online game may be transmitted to the game server 10 (S 106) and the game server 10 may stream the game execution screen and the game sounds into the terminals 21 to 29 on the basis of the user event (S107).

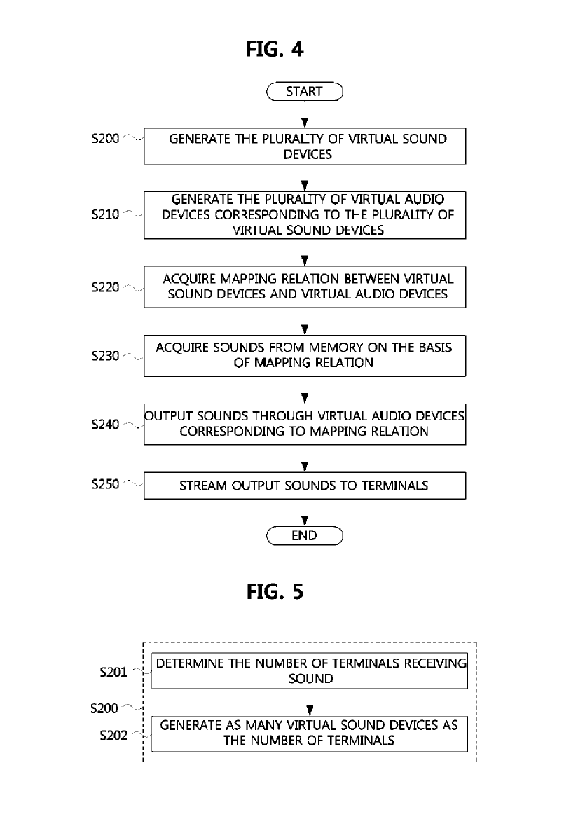

FIG. 4 is a flowchart showing a sound virtualization method according to an embodiment of the present invention.

Referring to FIG. 4, the sound virtualization method according to an embodiment of the present invention includes generating a plurality of virtual sound devices on the basis of a sound device (S200), generating a plurality of virtual audio devices on the basis of an audio device for outputting sound created by the sound device (S210), acquiring a mapping relation between sounds created by the plurality of virtual sound devices and sounds output by the plurality of virtual audio devices (S220), acquiring the sounds created by the plurality of virtual sound devices from memories on the basis of the mapping relation (S230), and outputting the sounds acquired from the memories through the virtual audio devices according to the mapping relation (S240).

Furthermore, the sound virtualization method according to an embodiment of the present invention may further include streaming the sounds output through the virtual audio devices into the terminals (S250).

Here, the sound device may denote a physical configuration for creating sounds, such as a sound card, and the virtual sound device may denote a logical configuration generated on the basis of the physical sound device. The audio device may denote a physical configuration for outputting the sound created by the sound device, and the virtual audio device may denote a logical configuration generated on the basis of the physical audio device.

The above operations may be performed by a sound virtualization apparatus 30 shown in FIG. 9. Detailed configurations and functions of the sound virtualization apparatus 30 will be described below.

In operation S200, the sound virtualization apparatus may generate a plurality of virtual sound devices on the basis of the sound device. A process of generating the plurality of virtual sound devices will be described below in detail with reference to FIG. 5.

FIG. 5 is a flowchart showing a process of generating a virtual sound device in a sound virtualization method according to an embodiment of the present invention.

Referring to FIG. 5, the generating of the plurality of virtual sound devices (S200) may include determining the number of terminals receiving sound (S201) and generating as many of the virtual sound devices as the determined number of terminals (S202).

In operation S201, the sound virtualization apparatus may determine the number of terminals receiving sound. That is, the sound virtualization apparatus may determine the number of terminals connecting to the game server to execute the online game (that is, to receive sound). That is, the sound virtualization apparatus may determine the number of terminals receiving sound on the basis of the number of terminals having previously connected to the game server to receive the online game service. Alternatively, the sound virtualization apparatus may determine the number of terminals receiving sound on the basis of the pre-registered number of users.

In operation S202, the sound virtualization apparatus may generate as many virtual sound devices as the number of terminals, which has been determined in operation S201. That is, the sound virtualization apparatus may generate as many of the virtual sound devices as the number of terminals, which has been determined in operation S201, generate more of the virtual sound devices than the number of terminals determined in operation S201 by a predetermined ratio (for example, 10% of the determined number of terminals), or generate fewer of the virtual sound devices than the number of terminals determined in operation S201 by a predetermined ratio (for example, 10% of the determined number of terminals).

The plurality of virtual sound devices generated through operation S200 may each have a unique index. For example, the plurality of virtual sound devices may be represented as a first virtual sound device, a second virtual sound device, a third virtual sound device, . . . , an nth virtual sound device.

Here, if there are n terminals to be provided with sound, the first virtual sound device may denote a sound device for creating sound to be transmitted to the first terminal, the second virtual sound device may denote a sound device for creating sound to be transmitted to the second terminal, and the third virtual sound device may denote a sound device for creating sound to be transmitted to the third terminal.

Returning to FIG. 4, in operation S210, the sound virtualization apparatus may generate a plurality of virtual audio devices on the basis of the audio device for outputting sound created by the sound device. Here, the sound virtualization apparatus may generate as many virtual audio devices as the number of virtual sound devices. For example, if the number of virtual sound devices generated through operation S200 is n, the sound virtualization apparatus may generate n virtual audio devices.

The plurality of virtual audio devices generated through operation S210 may each have a unique index. For example, the plurality of virtual audio devices may be represented as a first virtual audio device, a second virtual audio device, a third virtual audio device, . . . , an nth virtual audio device.

Also, the virtual audio devices may correspond to virtual sound devices, respectively. For example, the first virtual audio device may correspond to the first virtual sound device, the second virtual audio device may correspond to the second virtual sound device, and the third virtual audio device may correspond to the third virtual sound device. That is, sound to be transmitted to the nth terminal may be created by the nth virtual sound device, and sound created by the nth virtual sound device may be output through the nth virtual audio device.

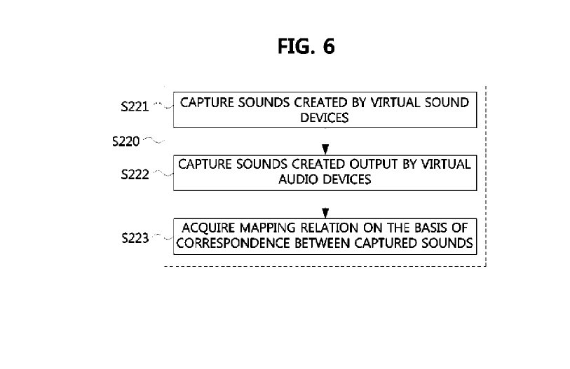

In operation S220, the sound virtualization apparatus may acquire a mapping relation between sounds created by the plurality of virtual sound devices and sounds output by the plurality of virtual audio devices. Hereinafter, a process of acquiring the mapping relation between the sounds will be described in detail with reference to FIG. 6.

FIG. 6 is a flowchart showing a process of acquiring a mapping relation in a sound virtualization method according to an embodiment of the present invention.

Referring to FIG. 6, the acquiring of the mapping relation between the sounds (S220) may include capturing sounds created by the plurality of virtual sound devices (S221), capturing sounds output by the plurality of virtual sound devices (S222), and acquiring the mapping relation on the basis of correspondence between the sounds captured by the plurality of virtual sound devices and the sounds captured by the plurality of virtual audio devices.

In operation S221, the sound virtualization apparatus may capture the sounds created by the plurality of virtual sound devices. For example, the sound virtualization apparatus may capture a first original sound created by the first virtual sound device, a second original sound created by the second virtual sound device, a third original sound created by the third virtual sound device, and an nth original sound created by the nth virtual sound device.

In operation S222, the sound virtualization apparatus may capture the sounds output by the plurality of virtual audio devices. For example, the sound virtualization apparatus may capture a first output sound output by the first virtual audio device, a second output sound output by the second virtual audio device, a third output sound output by the third virtual audio device, and an nth output sound output by the nth virtual audio device.

In operation S223, the sound virtualization apparatus may acquire the mapping relation on the basis of correspondence between the original sounds captured by the plurality of virtual sound devices and the output sounds captured by the plurality of virtual audio devices. That is, the sound virtualization apparatus may determine whether the original sounds captured by the plurality of virtual sound devices are the same as the output sounds captured by the plurality of virtual audio devices, and map the original sounds to the output sounds that are the same as the original sounds, respectively.

For example, the first original sound may be mapped to the third output sound if the first original sound and the third output sound are the same, the second original sound may be mapped to the first output sound if the second original sound and the first output sound are the same, and the third original sound may be mapped to the second output sound if the third original sound and the second output sound are the same. The above mapping relation may be represented using a mapping table such as Table 1 below.

TABLE 1

| MAPPING | VIRTUAL SOUND | VIRTUAL AUDIO |
|---|---|---|
| RELATION | DEVICE | DEVICE |
| MAPPING 1 | 1 | 3 |
| MAPPING 2 | 2 | 1 |
| MAPPING 3 | 3 | 2 |
| — | — | — |
| — | — | — |
| — | — | — |
| MAPPING n | n | n |

In an environment where there are a plurality of virtual sound devices and a plurality of virtual audio devices, since the nth original sound created by the nth virtual sound device is not necessarily output by the nth virtual audio device, the above mapping process may be used to output the nth original sound created by the nth virtual sound device through the nth virtual audio device.

Operations S200, S210, and S220 described above may denote a preprocessing process performed before the online game service is provided to a terminal. That is, the sound virtualization apparatus may acquire the mapping relation between the virtual sound devices and the virtual audio devices using a test sound, before providing the online game service to the terminal, and provide the online game service to the terminal using the acquired mapping relation.

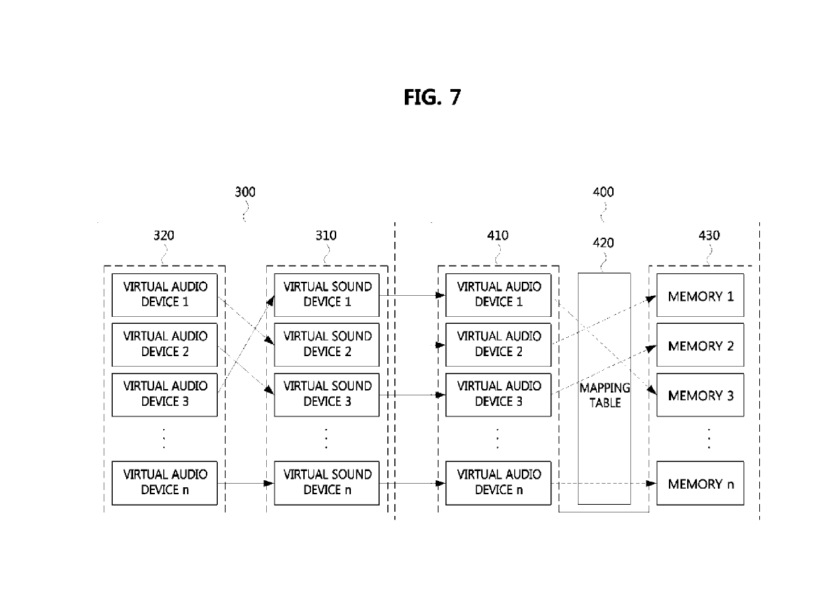

Operations S200, S210, and S220 will be further described below with reference to FIG. 7.

FIG. 7 is a conceptual diagram showing a process of outputting sound on the basis of the mapping relation according to an embodiment of the present invention.

Referring to FIG. 7, reference numeral 300 shows a process performed through operations S200, S210, and S220, and reference numeral 400 shows a process performed through operations S230, S240, S250, and S260.

The sound virtualization apparatus may generate a plurality of virtual sound devices 310 through operation S200, and a plurality of virtual audio devices 320 through operation S210. Then, the sound virtualization apparatus may acquire the mapping relation between the plurality of virtual sound devices 310 and the plurality of virtual audio devices 320 on the basis of whether the original sounds created by the plurality of virtual sound devices 310 and the output sounds created by the plurality of virtual audio devices 320 are the same.

For example, if the first original sound created by the first virtual sound device is the same as the third output sound output by the third virtual audio device, the sound virtualization device may map the first virtual sound device to the third virtual audio device. If the second original sound created by the second virtual sound device is the same as the first output sound output by the first virtual audio device, the sound virtualization device may map the second virtual sound device to the first virtual audio device. If the third original sound created by the third virtual sound device is the same as the second output sound output by the second virtual audio device, the sound virtualization device may map the third virtual sound device to the second virtual audio device.

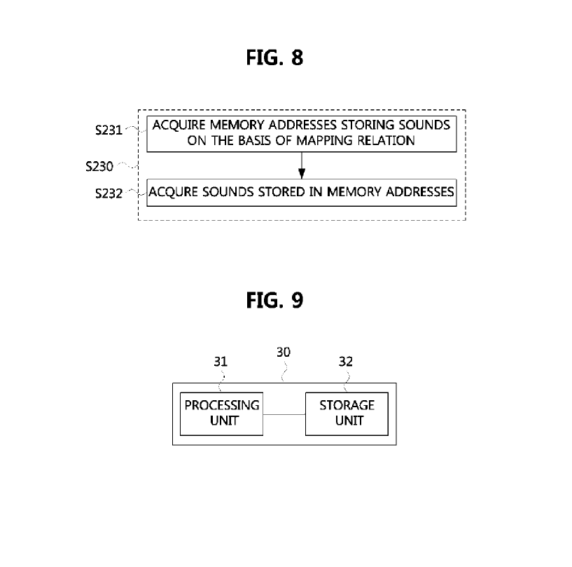

Returning to FIG. 4, in operation S230, the sound virtualization apparatus may acquire the sounds from memories on the basis of the mapping relation. The process of acquiring the sounds from the memory will be described below in detail with reference to FIG. 8.

FIG. 8 is a flowchart showing a process of acquiring sounds from memories in a sound virtualization method according to an embodiment of the present invention.

Referring to FIG. 8, the acquiring of the sounds from memories on the basis of the mapping relation (S230) may include acquiring memory addresses storing the sounds to be transmitted through the plurality of virtual audio devices (S231), and acquiring the sounds stored at the memory addresses (S232).

In operation S231, the sound virtualization apparatus may acquire the memory addresses storing the sounds to be transmitted through the plurality of virtual audio devices on the basis of the mapping relation.

Referring to Table 1, since the first virtual sound device is mapped to the third virtual audio device, the sound virtualization apparatus may acquire a third memory as the memory address storing the sound to be output through the first virtual audio device. Also, since the second virtual sound device is mapped to the first virtual audio device, the sound virtualization apparatus may acquire a first memory as the memory address storing the sound to be output through the second virtual audio device. Also, since the third virtual sound device is mapped to the second virtual audio device, the sound virtualization apparatus may acquire a second memory as the memory address storing the sound to be output through the third virtual audio device.

Here, the number of the memories may be the same as the number of the virtual sound devices, and a sound created by one virtual sound device may be stored in one of the memories. At this point, the memories may each have a unique index (for example, a first memory, a second memory, a third memory, . . . , an nth memory), and the sound created by each virtual sound device may be stored in any of the memories.

In operation S232, the sound virtualization apparatus may acquire the sounds stored at the memory addresses. With reference to the above description of operation S231, the sound virtualization apparatus may acquire a sound to be output through the first virtual audio device from the third memory, acquire a sound to be output through the second virtual audio device from the first memory, and acquire a sound to be output through the third virtual audio device from the second memory.

In operation S240, the sound virtualization apparatus may output the sounds acquired from the memories through the virtual audio devices according to the mapping relation. With reference to the above description of operation S232, the sound virtualization apparatus may output a sound acquired from the third memory through the first virtual audio device, output a sound acquired from the first memory through the second virtual audio device, and output a sound acquired from the second memory through the third virtual audio device.

In operation S250, the sound virtualization apparatus may stream the sounds to be output through the plurality of virtual audio devices into the terminals. With reference to the above description of operation S240, the sound virtualization apparatus may stream a sound to be output through the first virtual audio device into a corresponding terminal (that is, a terminal corresponding to the first virtual audio device), stream a sound to be output through the second virtual audio device into a corresponding terminal (that is, a terminal corresponding to the second virtual audio device), and stream a sound to be output through the third virtual audio device into a corresponding terminal (that is, a terminal corresponding to the third virtual audio device).

Returning to FIG. 7, the sound virtualization apparatus may acquire the sounds stored in the memories 430 using the mapping table 420, output the acquired sounds through the virtual audio devices 410 according to the mapping relation, and stream the output sounds into corresponding terminals.

The sound virtualization method according to the present invention may be implemented as program instructions executable by a variety of computers and recorded on a computer-readable medium. The computer-readable medium may include program instructions, data files, a data structure, or a combination thereof. The program instructions recorded on the computer-readable medium may be designed and configured specifically for the present invention, or may be publically known and available to those who are skilled in the field of software.

Examples of the computer-readable medium may include a hardware device such as ROM, RAM, and flash memory, which are specifically configured to store and execute program instructions. Examples of the program instructions can include machine codes made by, for example, a compiler, as well as high-level language codes executable by a computer using an interpreter. The above exemplary hardware devices can be configured to operate as one or more software modules in order to operate in an exemplary embodiment, and vice versa.

FIG. 9 is a block diagram showing a sound virtualization apparatus according to an embodiment of the present invention.

Referring to FIG. 9, the sound virtualization apparatus 30 may include a processing unit 31 and a storage unit 32.

The processing unit 31 may generate a plurality of virtual sound devices on the basis of the sound device, generate a plurality of virtual audio devices on the basis of the audio device for outputting sound created by the sound device, acquire a mapping relation between sounds created by the plurality of virtual sound devices and sounds output by the plurality of virtual audio devices, acquire sounds created by the plurality of virtual sound devices from memories on the basis of the mapping relation, and output the sounds acquired from the memories through virtual audio devices according to the mapping relation.

Furthermore, the processing unit 31 may stream sound output through each virtual audio device into a terminal.

Here, the sound device may denote a sound card, which is a physical configuration for creating a sound, or a logical configuration generated on the basis of the physical sound device. The audio device may denote a physical configuration for outputting the sound created by the sound device, and the virtual audio device may denote a logical configuration generated on the basis of the physical audio device.

When generating the plurality of virtual sound devices, the processing unit 31 may determine the number of terminals receiving sound and generate as many of the virtual sound devices as the determined number of terminals.

Specifically, the processing unit 31 may determine the number of terminals that connect to the game server to execute the online game (that is, to receive sound). At this point, the processing unit 31 may determine the number of terminals to receive sound on the basis of the number of terminals having previously connected to the game server to receive the online game service. Alternatively, the processing unit 31 may determine the number of terminals to receive sound on the basis of the pre-registered number of users.

The processing unit 31 may generate as many of the virtual sound devices as the number of the determined number of terminals. That is, the processing unit 31 may generate as many of the virtual sound devices as the number of terminals, generate more of the virtual sound devices than the number of terminals determined in operation S201 by a predetermined ratio (for example, 10% of the determined number of terminals), or generate fewer of the virtual sound devices than the number of terminals determined in operation S201 by a predetermined ratio (for example, 10% of the determined number of terminals).

The plurality of virtual sound devices generated through the above process may each have a unique index. For example, the plurality of virtual sound devices may be represented as a first virtual sound device, a second virtual sound device, a third virtual sound device, . . . , an nth virtual sound device.

Here, if there are n terminals to be provided with sound, the first virtual sound device may denote a sound device for creating sound to be transmitted to the first terminal, the second virtual sound device may denote a sound device for creating sound to be transmitted to the second terminal, and the third virtual sound device may denote a sound device for creating sound to be transmitted to the third terminal.

The processing unit 31 may generate the plurality of virtual audio devices on the basis of the audio device for outputting sound created by the sound device. Here, the processing unit 31 may generate as many of the virtual audio devices as the number of the virtual sound devices. For example, if the number of virtual sound devices is n, the processing unit 31 may generate n virtual audio devices.

The plurality of virtual audio devices generated through the above process may each have a unique index. For example, the plurality of virtual audio devices may be represented as a first virtual audio device, a second virtual audio device, a third virtual audio device, . . . , an nth virtual audio device.

Also, the virtual audio devices may correspond to virtual sound devices, respectively. For example, the first virtual audio device may correspond to the first virtual sound device, the second virtual audio device may correspond to the second virtual sound device, and the third virtual audio device may correspond to the third virtual sound device. That is, the sound to be transmitted to the nth terminal may be created by the nth virtual sound device, and the sound created by the nth virtual sound device may be output through the nth virtual audio device.

When acquiring the mapping relation between sounds, the processing unit 31 may capture sounds created by the plurality of virtual sound devices, respectively, capture sounds output by the plurality of virtual audio devices, respectively, and acquiring a mapping relation on the basis of correspondence between the sounds captured by the plurality of virtual sound devices and the sounds captured by the plurality of virtual audio devices.

For example, the processing unit 31 may capture the first original sound created by the first virtual sound device, the second original sound created by the second virtual sound device, the third original sound created by the third virtual sound device, and the nth original sound created by the nth virtual sound device.

Also, the processing unit 31 may capture the first output sound output by the first virtual audio device, the second output sound output by the second virtual audio device, the third output sound output by the third virtual audio device, and the nth output sound output by the nth virtual audio device.

The processing unit 31 may determine whether the original sounds captured by the plurality of virtual sound devices are the same as the output sounds captured by the plurality of virtual audio devices, and map the original sounds to the output sounds that are the same as the original sounds, respectively.

For example, the first original sound may be mapped to the third output sound if the first original sound and the third output sound are the same, the second original sound may be mapped to the first output sound if the second original sound and the first output sound are the same, and the third original sound may be mapped to the second output sound if the third original sound and the second output sound are the same. The above mapping relation may be represented using a mapping table such as Table 1 above.

When acquiring the sounds from memories on the basis of the mapping relation, the processing unit 31 may acquire memory addresses storing the sounds to be transmitted through the plurality of virtual audio devices and acquire the sounds stored at the memory addresses.

Referring to Table 1 above, since the first virtual sound device is mapped to the third virtual audio device, the processing unit 31 may acquire a third memory as the memory address storing the sound to be output through the first virtual audio device. Also, since the second virtual sound device is mapped to the first virtual audio device, the processing unit 31 may acquire a first memory as the memory address storing the sound to be output through the second virtual audio device. Also, since the third virtual sound device is mapped to the second virtual audio device, the processing unit 31 may acquire a second memory as the memory address storing the sound to be output through the third virtual audio device.

Here, the number of the memories may be the same as the number of the virtual sound devices, and a sound created by one virtual sound device may be stored in one of the memories. At this point, the memories may each have a unique index (for example, a first memory, a second memory, a third memory, . . . , an nth memory), and the sound created by each virtual sound device may be stored in any of the memories.

The processing unit 31 may acquire the sounds stored at the memory addresses. With reference to the above description, the processing unit 31 may acquire the sound to be output through the first virtual audio device from the third memory, acquire the sound to be output through the second virtual audio device from the first memory, and acquire the sound to be output through the third virtual audio device from the second memory.

The processing unit 31 may output the sounds acquired from the memories through the virtual audio devices according to the mapping relation. With reference to the above description, the processing unit 31 may output the sound acquired from the third memory through the first virtual audio device, output the sound acquired from the first memory through the second virtual audio device, and output the sound acquired from the second memory through the third virtual audio device.

The processing unit 31 may stream the sound to be output through each virtual audio device into the terminal. With reference to the above description, the processing unit 31 may stream the sound to be output through the first virtual audio device into a corresponding terminal (that is, a terminal corresponding to the first virtual audio device), stream the sound to be output through the second virtual audio device into a corresponding terminal (that is, a terminal corresponding to the second virtual audio device), and stream the sound to be output through the third virtual audio device into a corresponding terminal (that is, a terminal corresponding to the third virtual audio device).

Here, the processing unit 31 may include a processor and a memory. The processor may denote a general-purpose processor (for example, a central processing unit (CPU), etc.) or a special-purpose processor for performing the sound virtualization method. The memory may store a program code for performing the sound virtualization method. That is, the processor may read the program code stored in the memory and perform each operation of the sound virtualization method on the basis of the read program code.

The storage unit 32 may store information that has been processed and information that is to be processed by the processing unit 31. That is, the storage unit 32 may store information about the plurality of virtual sound devices, information about the plurality of virtual audio devices, information about the memory, information about the mapping relation, etc.

According to the present invention, it is possible to provide sound to a plurality of users through virtualization of a sound device.

While the example embodiments of the present invention and their advantages have been described in detail, it should be understood that various changes, substitutions, and alterations may be made herein without departing from the scope of the invention as defined by the following claims.

What is claimed is:

1. A sound virtualization method comprising:
generating a plurality of virtual sound devices on the basis of a sound device;
generating a plurality of virtual audio devices on the basis of an audio device for outputting sound created by the sound device;
acquiring a mapping relation between sounds created by the plurality of virtual sound devices and sounds output by the plurality of virtual audio devices;
acquiring the sounds created by the plurality of virtual sound devices from memory on the basis of the mapping relation; and
outputting the sounds acquired from the memory through the plurality of virtual audio devices corresponding to the mapping relation.

2. The sound virtualization method of claim 1, wherein the generating of the plurality of virtual sound devices comprises:
determining the number of terminals receiving the sounds; and
generating as many of the virtual sound devices as the determined number of terminals.

3. The sound virtualization method of claim 1, wherein the generating of the plurality of virtual audio devices comprises generating as many of the virtual audio devices as the number of the virtual sound devices.

4. The sound virtualization method of claim 1, wherein the acquiring of a mapping relation comprises:
capturing the sounds created by the plurality of virtual sound devices;
capturing the sounds output by the plurality of virtual audio devices; and
acquiring the mapping relation on the basis of correspondence between the sounds captured by the plurality of virtual sound devices and the sounds captured by the plurality of virtual audio devices.

5. The sound virtualization method of claim 1, wherein the acquiring of the sounds created by the plurality of virtual sound devices from memory on the basis of the mapping relation comprises:
acquiring memory addresses storing the sounds to be transmitted through the plurality of virtual audio devices; and
acquiring the sounds stored at the memory addresses.

6. The sound virtualization method of claim 1, further comprising streaming the sounds output through the plurality of virtual audio devices into a terminal.

7. The sound virtualization method of claim 1, wherein the mapping relation is a one-to-one mapping between one of the sounds created by the plurality of virtual sound devices and one of the sounds output by the plurality of virtual audio devices.

8. A sound virtualization apparatus comprising:
a processing unit configured to generate a plurality of virtual sound devices on the basis of a sound device, generate a plurality of virtual audio devices on the basis of an audio device for outputting sound created by the sound device, acquire a mapping relation between sounds created by the plurality of virtual sound devices and sounds output by the plurality of virtual audio devices, acquire the sounds created by the plurality of virtual sound devices from memory on the basis of the mapping relation, and output the sounds acquired from the memory through the virtual audio devices corresponding to the mapping relation; and
a storage unit configured to store information that has been processed and information that is to be processed by the processing unit.

9. The sound virtualization apparatus of claim 8, wherein the processing unit, upon the generating of the plurality of virtual sound devices, determines the number of terminals to receive the sounds and generates as many of the virtual sound devices as the determined number of terminals.

10. The sound virtualization apparatus of claim 8, wherein the processing unit, upon the generating of the plurality of virtual audio devices, generates as many of the virtual audio devices as the number of the virtual sound devices.

11. The sound virtualization apparatus of claim 8, wherein the processing unit, upon the acquiring of the mapping relation, captures the sounds created by the plurality of virtual sound devices, captures the sounds output by the plurality of virtual audio devices, and acquires the mapping relation on the basis of correspondence between the sounds captured by the plurality of virtual sound devices and the sounds captured by the plurality of virtual audio devices.

12. The sound virtualization apparatus of claim 8, wherein the processing unit, upon the acquiring of the sounds from memory on the basis of the mapping relation, acquires memory addresses storing the sounds to be transmitted through the plurality of virtual audio devices and acquires the sounds stored at the memory addresses.

13. The sound virtualization apparatus of claim 8, wherein the processing unit is further configured to stream the sounds output through the plurality of virtual audio devices into terminals.

14. The sound virtualization apparatus of claim 8, wherein the mapping relation is a one-to-one mapping between one of the sounds created by the plurality of virtual sound devices and one of the sounds output by the plurality of virtual audio devices.
